(19) United States
(12) Patent Application Publication
(10) Pub. No.: US 2009/0178712 A1
(43) Pub. Date: Jul. 16, 2009

(54) Flow Splitter for Fluid Pipe

(75) Inventors: John Allen Broadbent, Centennial, CO (US); Richard Kepler, Aurora, CO (US)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Mile High Equipment L.L.C.

(21) Appl. No.: 12/343,802

(22) Filed: Dec. 24, 2008

Related U.S. Application Data
(60) Provisional application No. 61/009,252, filed on Dec. 27, 2007.

(51) Int. Cl. F15C 3/00; F16K 1/00

(52) U.S. Cl. 137/1; 137/874

(57) ABSTRACT

The present disclosure provides a flow splitter for dividing a flow of a fluid into a first outlet and a second outlet. The flow splitter comprises a pivot having a flapper portion, which can ensure that water will continue to flow to an outlet, even if the outlet is partially or completely obstructed.

### CROSS-REFERENCE TO RELATED APPLICATIONS

The present application claims the benefit of U.S. Provisional Application No. 61/009,252, filed on Dec. 27, 2007.

### BACKGROUND OF THE DISCLOSURE

1. Field of the Disclosure

The present disclosure provides a flow splitter. More particularly, the present disclosure provides a flow splitter for a fluid inlet, to ensure that the fluid flow is split as desired between two water outlets.

2. Discussion of the Related Art

It is often desirable to divert a source of water to two separate outlet flow streams. Often, however, there will be an obstruction or other disruption of flow in one of the outlet streams, which will cause an uneven pressure to develop between the two outlets. In this case, water will rush to the unobstructed outlet, due to the lower pressure. It is often desirable to continue to supply fluid to an outlet even when it is obstructed. This requires forcing the water to go against its natural tendency. There is no device currently available which can provide this capability.

### SUMMARY OF THE DISCLOSURE

The present disclosure provides a flow splitter for directing a flow of fluid into a first portion and a second portion. The flow splitter comprises an inlet for receiving said flow of fluid, a first outlet for receiving the first portion, and a second outlet for receiving the second portion, and a pivot having a flapper that selectively reduces the amount of fluid directed to the first portion or the second portion by at least partially closing off an end of the first outlet or the second outlet, respectively. The flapper is moved by a pressure applied by the fluid on a side of the flapper.

In another embodiment, the present disclosure provides a method of diverting a flow of fluid into a first portion and a second portion. The method comprises the steps of supplying the flow of fluid, diverting at least a portion of the flow of fluid into a first portion and a second portion, and using a device disposed within the flow of fluid to obstruct the flow into the first portion or second portion, based on a pressure exerted on the device disposed within the flow of fluid.

### BRIEF DESCRIPTION OF THE DRAWINGS

FIG. 1 shows a perspective view of the flow splitter of the present disclosure; and

FIG. 2 shows a cross-sectional view of the flow-splitter of FIG. 1.

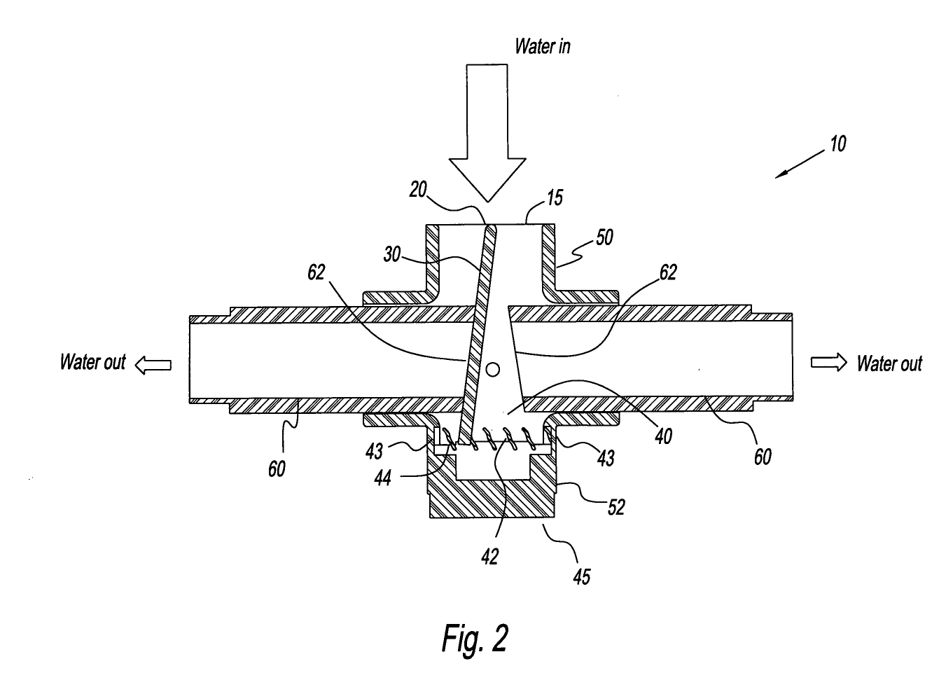

### DETAILED DESCRIPTION OF THE PRESENT DISCLOSURE

The present disclosure provides a flow splitter 10 that can be fitted to a pipe. Flow splitter 10 comprises an opening 15, a pivot 20, a flapper 30, a device 40 for applying tension or restoring force to flapper 30, a base 45, an inlet 50, a lower portion 52, and a pair of outlets 60. Flow splitter 10 provides a mechanism by which a fluid entering opening 15 can be diverted in a direction that is the opposite of the natural direction of flow the fluid would otherwise take. If a first one of the two outlets 60 is somehow completely or partially obstructed, or at least more so that the second outlet 60, without the presence of flow splitter 10, the fluid would be more inclined to flow towards the second outlet 60. Flow splitter 10 helps to ensure that water will continue to be directed into an obstructed outlet, even if the fluid would otherwise be inclined to flow away from that outlet.

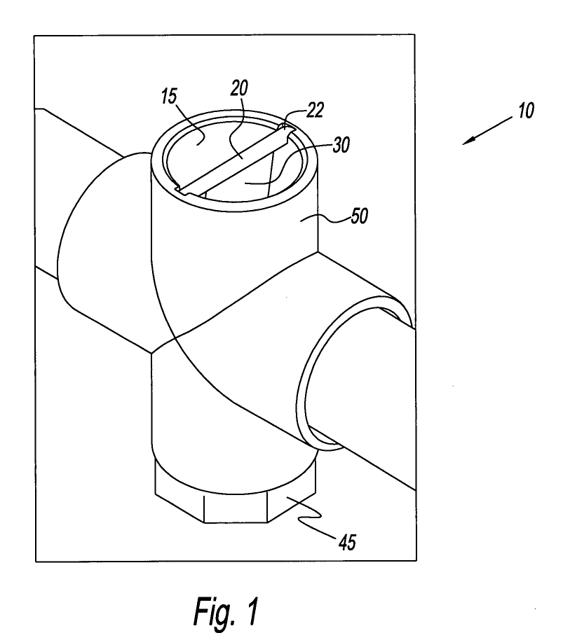

Flapper 30 is connected or attached to pivot 20. Pivot 20 can also be formed as one integral component with flapper 30. Pivot 20 can have two pivot ends 22 that can be connected to inlet 50 in such a way that flapper 30 can rotate about pivot 20 within inlet 50, about a longitudinal axis of pivot 20. In the embodiment shown in FIG. 1, for example, pivot ends 22 sit within divots disposed on an inner diameter of inlet 50.

When fluid enters opening 15, it can be diverted through one or both of outlets 60. Under normal circumstances, the fluid would flow in both directions, with a preference for whichever direction offered the least amount of resistance. With flow splitter 10, however, the fluid flow can be directed in the opposite direction, namely toward the path of higher resistance.

In the shown embodiment, device 40 is a spring. The present disclosure, however, contemplates the use of any other devices that can apply the desired restoring force to center flapper 30 when the flow is even, such as an elastomeric material, provided that the device is suitable for contact with potable water if necessary. Spring 40 is disposed within lower portion 52, and connected to an inner wall of bottom portion 52. The ends of spring 40 are connected to pockets 43 molded into the side of bottom portion 52, so that the ends of spring 40 are disposed within these pockets. When base 45 is attached to flow splitter 10, it retains the ends of spring 40 by holding the ends of spring 40 in place.

Spring 40 can be described as having a first half 42 and a second half 44 located on either side of flapper 30. The end of flapper 30 is positioned within, or connected to, spring 40 such that first half 42 is located on one side of flapper 30, and second half 44 is located on the opposite side of flapper 30. In a normal flow situation, i.e. where each of the outlets 60 have an equal amount of resistance to fluid flow, spring 40 will keep flapper 30 centered within housing 50 such that the fluid can flow equally to both outlets 60.

Outlets 60 have tapered edges 62. In a situation where one outlet 60 is more restricted or obstructed than the other outlet 60, the flapper 30 will be pushed or directed toward the less restricted outlet 60 that has more flow. This occurs because the fluid disposed near tapered end 62 of the more obstructed outlet 60 will push on flapper 30 at a higher pressure than fluid disposed on an opposite side of flapper 30 and near the less obstructed outlet 60. The less obstructed outlet 60 will be at least partially closed off by flapper 30, encouraging the fluid to preferentially flow through the more obstructed outlet 60.

Flapper 30, spring 40, and the rest of the components of flow splitter 10 described above can be made of any material suitable for fluid contact or, if necessary, potable water if flow splitter 10 is used in such an application, such as any number of plastics and metals. In one embodiment, flapper 30 is made of plastic, and spring 40 is made of stainless steel.

Flow splitter 10 can be used in any application, with any fluid, where it is desirable to split a flow of the fluid in the manner described above. One particular application in which flow splitter 10 has proven to be particularly successful is in ice-making machines. Such machines often comprise two water tubes, where water is frozen within the tubes, and then ejected once it has frozen. These water tubes can be connected to, or in fluid communication with, outlets 60 of flow-splitter 10. What often happens in these ice-making machines is that the ice formed within one tube is harvested before the ice in the other tube is harvested. In this situation, the fluid entering the water tubes will naturally be inclined to pass through the first tube, since there is much less resistance to fluid flow within that tube. This is an undesirable situation, because if all the water flows into the first tube, the ice within the second tube will never be completely ejected during harvest, since not enough water will travel into the second tube. Thus, by ensuring that the fluid flow passes through the second tube, flow splitter 10 ensures a proper harvest of ice from the second tube.

While the instant disclosure has been described with reference to one or more exemplary or preferred embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this invention, but that the invention will include all embodiments falling within the scope as described herein.

What is claimed is:

1. A flow splitter for directing a flow of fluid into a first portion and a second portion, said flow splitter comprising:
an inlet for receiving said flow of fluid;
a first outlet for receiving said first portion, and a second outlet for receiving said second portion; and
a pivot having a flapper that selectively reduces the amount of fluid directed to the first portion or the second portion by at least partially closing off an end of the first outlet or the second outlet, respectively,
wherein said flapper is moved by a pressure applied by said fluid on a side of said flapper.

2. The flow splitter of claim 1, further comprising:
a bottom end opposite said inlet; and
a device connected to an end of said flapper,
wherein said device is connected to an inner wall of said bottom end, and
wherein said device provides a restoring force to center the position of said flapper.

3. The flow splitter of claim 2, wherein said tension device is a spring.

4. The flow splitter of claim 1, wherein said fluid is water.

5. A method of diverting a flow of fluid into a first portion and a second portion, the method comprising the steps of:
supplying said flow of fluid;
diverting at least a portion of said flow of fluid into said first portion and said second portion; and
using a device disposed within the flow of fluid to obstruct the flow into the first portion or second portion, based on a pressure exerted on the device disposed within the flow of fluid.

6. The method of claim 5, wherein said first portion and said second portion of said flow of fluid are in fluid communication with water tubes of an ice-making machine, wherein said fluid is water, and wherein said fluid is frozen within said water tubes.
